(19) United States
(12) Patent Application Publication
(10) Pub. No.: US 2013/0211771 A1
(43) Pub. Date: Aug. 15, 2013

(54) MANIPULATING HEAT FLUX BIFURCATION & DISPERSION INSIDE POROUS MEDIA FOR HEAT TRANSFER CONTROL

(71) Applicants: Kambiz Vafai, Mission Viejo, CA (US); Kun Yang, (US)

(72) Inventors: Kambiz Vafai, Mission Viejo, CA (US); Kun Yang, (US)

(73) Assignee: Kambix Innovations, LLC.

(21) Appl. No.: 13/590,435

(22) Filed: Aug. 21, 2012

Related U.S. Application Data
(60) Provisional application No. 61/598,060, filed on Feb. 13, 2012.

(51) Int. Cl. G01K 17/00; G06F 15/00

(52) U.S. Cl. 702/136

(57) ABSTRACT

A method, system and apparatus for analyzing heat flux bifurcation within a porous medium by analyzing a convective heat transfer process within a channel partially filled with a porous medium under local thermal non-equilibrium conditions. Either the thermal dispersion effect or the inertial effect can be considered in a physical model. Exact solutions can be derived for both fluid and solid temperature distributions for three interface thermal models at a porous-fluid interface. The required conditions for validity of each interface thermal model can be obtained, and equivalence correlations between different interface thermal models can be developed. The range of validity of local thermal equilibrium condition can be established, and heat flux bifurcation within a porous medium can be established and demonstrated. Furthermore, a Nusselt number can be obtained and investigated for pertinent parameters.

### CROSS-REFERENCE TO PROVISIONAL PATENT APPLICATION

This patent application claims the benefit under 35 U.S.C. §119(e) of U.S. Provisional Application Ser. No. 61/598,060 entitled, “Methods and Systems for Heat Flux Bifurcation in Porous Media,” which was filed on Feb. 13, 2012 and is incorporated herein by reference in its entirety.

### TECHNICAL FIELD

Embodiments are generally related to heat transfer in porous medium. Embodiments also relate to heat flux bifurcation in porous medium. Embodiments are additionally related to solutions for heat flux bifurcation within porous media incorporating inertial and/or dispersion effects.

### BACKGROUND OF THE INVENTION

Local Thermal Equilibrium (LTE) and Local Thermal Non-Equilibrium (LTNE) models are two primary techniques for representing heat transfer in a porous medium. The LTNE model has gained increased attention in recent years, since the assumption of local thermal equilibrium is not valid and the temperature difference between the fluid and solid phases within the porous media are significant in a wide range of applications such as geothermal engineering, heat pipe, electronic cooling, enhanced oil recovery, solar energy utilization, and heat transfer enhancement. The internal heat exchange between the fluid and solid phases for LTNE model is complicated under some specified conditions and will cause the phenomenon of heat flux bifurcation in porous medium.

The work of K. Yang, K. Vafai, Analysis of temperature gradient bifurcation in porous media—an exact solution, International Journal of Heat and Fluid Flow, 2010, 53: 4316-4325 was one of the first attempts to study the heat flux bifurcation phenomenon in porous media. Exact solutions are obtained for both the fluid and solid temperature distributions for convective heat transfer within a channel filled with a porous medium subject to a constant wall heat flux boundary condition, with internal heat generation in both the fluid and solid phases. The necessary conditions are derived for temperature gradient bifurcation for the fluid and solid phases at the channel wall. Furthermore, K. Yang, K. Vafai, Transient Aspects of Heat Flux Bifurcation in Porous Media-an Exact Solution, ASME Journal of Heat Transfer, 2011, 133, 052602 demonstrated the existence of two primary types of heat flux bifurcations at the wall under temporal conditions. Heat flux bifurcation in porous media can be considered as a general phenomenon under LTNE condition.

The composite system which consists of a fluid-saturated porous medium and an adjacent fluid layer has received considerable attention due to its wide range of engineering applications. D. Poulikakos, M. Kazmierczak, Forced convection in a duct partially filled with a porous material, ASME Journal of Heat Transfer,1987, 109: 653-662 studied the forced convection in a duct (parallel plates or circular pipe) partially filled with a porous material. The Brinkman-modified Darcy model was used to model the flow in the porous medium. The results showed that the change of Nusselt number with the thickness of the porous region is not monotonic. S. Chikh, A. Boumedien, K. Bouhadef, G. Lauriat, Analytical solution of non-Darcian forced convection in an annular duct partially filled with a porous medium, International Journal of Heat and Mass Transfer, 1995, 38(9): 1543-1551 obtained analytical solution of forced convection in an annular duct partially filled a porous medium by using the Brinkman-modified Darcy model. It was found that it may not be necessary to fill the duct completely to attain the maximum heat transfer for highly permeable and conducting material.

M. K. Alkam, M. A. Al-Nimr, M. O. Hamdan, Enhancing heat transfer in parallel-plate channels by using porous inserts, International Journal of Heat and Mass Transfer, 2001, 44: 931-938 numerically investigated the heat transfer enhancement characteristics in the developing region of parallel-plate ducts by attaching a high thermal conductivity porous substrate to the inner wall of one plate. A. A. Mohamad, Heat transfer enhancements in heat exchangers fitted with porous media Part I: constant wall temperature, International Journal of Thermal Sciences, 2003, 42 (4): 385-395 numerically investigated the heat transfer in a pipe or a channel by partially inserting the porous materials at the core of the conduit. It has been found that the heat transfer can be enhanced with a reasonable pressure drop.

A. V. Kuznetsov, Analytical Studies of Forced Convection in Partly Porous Configurations, Handbook of Porous Media, K. Vafai, ed., Dekker, New York, 2000, 269-315 has obtained some solutions for the velocity and temperature distributions for some composite geometrical configurations involving the fluid-porous interface. The LTE model was used in the above-mentioned studies. The phenomenon of heat flux bifurcation in porous media was established for the first time in the work of K. Yang, K. Vafai, Transient Aspects of Heat Flux Bifurcation in Porous Media: An Exact Solution, ASME Journal of Heat Transfer, 2011, 133, 052602.

For the composite systems, the fluid flow and heat transfer boundary conditions at the interface between a porous medium and a fluid have a pronounced effect on the velocity and temperature fields. See G. S. Beavers, D. D. Joseph, Boundary conditions at a naturally permeable wall, J. Fluid Mech. 1967, 30(1): 197-207, K. Vafai, R. Thiyagaraja, Analysis of Flow and Heat Transfer at the Interface Region of a Porous Medium, International Journal of Heat and Mass Transfer, 1987, 30: 1391-1405, K. Vafai, S. Kim, Fluid Mechanics of the Interface Region Between a Porous Medium and a Fluid Layer—An Exact Solution, International Journal of Heat and Fluid Flow, 1990, 11: 254-256, and B. Alazmi, K. Vafai, Analysis of Fluid Flow and Heat Transfer Interfacial Conditions between a Porous Medium and a Fluid Layer, International Journal of Heat and Mass Transfer, 2001, 44: 1735-1749.

When LTE model is used, the continuity of temperature and heat flux can be utilized as the boundary conditions at the interface. However, since the temperatures of fluid and solid phases are different in porous media for LTNE model, an additional thermal boundary condition should be given at the interface. D. Jamet, M. Chandesris, On the intrinsic nature of jump coefficients at the interface between a porous medium and a free fluid region, International Journal of Heat and Mass Transfer, 2009, 52(1-2): 289-300 discussed the physical nature of the coefficients for jump boundary conditions at fluid-porous interface. A. d′Hueppe, M. Chandesris, D. Jamet, B. Goyeau, Boundary conditions at a fluid—porous interface for a convective heat transfer problem: Analysis of the jump relations, International Journal of Heat and Mass Transfer, 2011, 54(15-16): 3683-3693 investigated the jump relations at the fluid-porous interface under LTE conditions and obtained the location of an apparent interface where the condition of continuity is sufficient.

To avoid specifying the fluid-porous interface conditions, Carlos G. Aguilar-Madera, Francisco J. Valdes-Parada, BenoitGoyeau, J. Alberto Ochoa-Tapia, Convective heat transfer in a channel partially filled with a porous medium, International Journal of Thermal Sciences, 2011, 50(8): 1355-1368 adopted a one-domain approach to investigate the convective heat transfer in a parallel-plate channel partially filled with a porous medium. Carlos G. Aguilar-Madera, Francisco J. Valdes-Parada, BenoitGoyeau, J. Alberto Ochoa-Tapia, Convective heat transfer in a channel partially filled with a porous medium, International Journal of Thermal Sciences, 2011, 50(8): 1355-1368 presented the heat flux jump conditions at the interface for LTNE model, in which an excess surface heat transfer coefficient was introduced to control the total heat flux distribution between the solid and fluid phases at the interface. Carlos G. Aguilar-Madera, Francisco J. Valdes-Parada, BenoitGoyeau, J. Alberto Ochoa-Tapia, One-domain approach for heat transfer between a porous medium and a fluid, International Journal of Heat and Mass Transfer, 2011, 54(9-10): 2089-2099 studied the accuracy of the LTE and LTNE models within the inter-region using one-domain approach. K. Yang, K. Vafai, Restrictions on the Validity of the Thermal Conditions at the Porous-Fluid Interface-an Exact Solution, in press for ASME Journal of Heat Transfer investigated five of the most fundamental forms of thermal conditions at the interface between a porous medium and a fluid under LTNE condition and established the restrictions on the validity of each thermal condition.

The inertia and thermal dispersion effects become significant in a number of applications such as when dealing with high speed flows and high porosity medium. K. Vafai, C. L. Tien, Boundary and inertia effects on flow and heat transfer in porous media, International Journal of Heat and Mass Transfer, 1981, 24: 195-203 discussed the boundary and inertia effects on flow and heat transfer in porous media. An error map was presented to illustrate the applicability of Darcy's law. A. Amiri, K. Vafai, Analysis of Dispersion Effects and Non-Thermal Equilibrium Non-Darcian, Variable Porosity Incompressible Flow Through Porous Medium, International Journal of Heat and Mass Transfer, 1994, 37: 939-954 presented a comprehensive analysis of the effects of the inertial, boundary, porosity variation, and thermal dispersion effects, as well as the validity of local thermal equilibrium assumption in porous media. J. Y. Jang, J. L Chen, Forced convection in a parallel plate channel partially filled with a high porosity medium, Int. Corn. Heat Mass Transfer, 1992,19: 263-273 numerically investigated the non-Darcy and thermal dispersion effects on the fully developed forced convection parallel plate channel partially filled with a high porosity medium. N. Jeong, D. H. Choi, Estimation of the thermal dispersion in a porous medium of complex structures using a lattice Boltzmann method, Int. J. Heat Mass Transfer (2011), doi:10.1016/j.ijheatmasstransfer.2011.05.003 analyzed the thermal dispersion in a porous medium by using the lattice Boltzmann method. Atul Kumar Singh, PratibhaAgnihotri, N. P. Singh, Ajay Kumar Singh, Transient and non-Darcian effects on natural convection flow in a vertical channel partially filled with porous medium: Analysis with Forchheimer—Brinkman extended Darcy model, International Journal of Heat and Mass Transfer, 2011, 54, (5-6): 1111-1150 analyzed the non-Darcian effects on natural convection flow in a vertical channel partially filled with a porous medium. Alkam et al. and Mohamad also discussed the influence of inertia effects in porous media.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for heat transfer in a porous medium.

It is another aspect of the disclosed embodiments to provide for heat flux bifurcation in a porous medium.

It is a further aspect of the disclosed embodiments to provide for an exact solution for heat flux bifurcation inside porous media incorporating inertial and dispersion effects.

It is a further aspect of the disclosed embodiments to provide for a method and system for analyzing heat flux bifurcation inside a porous medium by studying the convective heat transfer process within a channel partially filled with a porous medium under local thermal non-equilibrium conditions.

The aforementioned aspects and other objectives and advantages can now be achieved as described herein. The phenomenon of heat flux bifurcation within a porous medium can be analyzed. Convective heat transfer within a channel partially filled with a porous medium under LINE model, with consideration of both the thermal dispersion and inertial effects, can be investigated analytically. Exact solutions for the fluid and solid temperature distributions and Nusselt number for three interface thermal models at the porous-fluid interface can also be derived. A range of validity of all the interface thermal models can be established. The equivalence correlations between different interface thermal models can be developed. When the heat transfer between the fluid and solid phases does not approach infinity, and the temperatures are not equal at the porous-fluid interface, the phenomenon of heat flux bifurcation will occur inside the porous media. The average temperature difference between the fluid and solid phases inside the porous media, in which the phenomenon of heat flux bifurcation should be considered, can be utilized to determine the LTE condition.

Results demonstrate that a critical dimensionless half height of the porous media is a proper parameter, below which the LTE condition within porous region is considered to be valid. Furthermore, the Darcy number and the half height of the porous media are the two major parameters which influence the thermal dispersion effect and the inertial effect. It is also found that the thermal dispersion effect becomes weaker when the inertial effect is incorporated and the inertial effect becomes weaker when the thermal dispersion effect is incorporated.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic diagram of a physical model and a corresponding coordinate system, in accordance with the disclosed embodiments;

FIGS. 2A and 2B illustrates graphs showing β_{cr} distributions for pertinent parameters Bᵢ, k₀ and Reₚ for ε=0.8, in accordance with the disclosed embodiments;

FIGS. 3A-3C illustrates graphs showing dimensionless temperature distributions for Model B for α*=0.78, Da=1×10⁻⁴ and ε=0.8, in accordance with the disclosed embodiments;

FIG. 4 illustrates graph showing dimensionless total heat flux distributions at the interface for α*=0.78, in accordance with the disclosed embodiments;

FIGS. 5A and 5B illustrates graphs showing η₀ distributions for pertinent parameters Bᵢ, k₀ and Reₚ for ε=0.8, in accordance with the disclosed embodiments;

FIGS. 6A and 6B illustrates graphs showing Q₁, Qᵢₙₜ, and Qᵢ+QWᵢₙₜ distributions for pertinent parameters Reₚ, Bi and Biᵢₙₜ for α*=0.78, Da=1×10⁻⁴ and ε=0.8, in accordance with the disclosed embodiments;

FIGS. 7A and 7B illustrates graphs showing η_{1,cr} variations as a function of Da for α*=0.78 and ε=0.8, in accordance with the disclosed embodiments;

FIG. 8 illustrates a graph showing η_{1,cr} variations as a function of Biᵢₙₜ for α*=0.78 and ε=0.8, in accordance with the disclosed embodiments;

FIGS. 9A and 9B illustrates graphs showing Nusselt number variations as a function of pertinent parameters Bi, Biᵢₙₜ, Reₚ, Λ_{H} and Da for α*=0.78 and ε=0.8, in accordance with the disclosed embodiments;

FIGS. 10A and 10B illustrates graphs showing DNu_{T} distributions for pertinent parameters Bi, Biᵢₙₜ, Reₚ, Λ_{H} and Da for α*=0.78 and ε=0.8, in accordance with the disclosed embodiments; and

FIGS. 11A-11D illustrates graphs showing DNu_{F} distributions for pertinent parameters Bi, Biᵢₙₜ, Reₚ, Λ_{H} and Da for α*=0.78 and ε=0.8, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The following defines various symbols and meanings utilized herein:

TABLE 1

| | |
|---|---|
| Bi | $Bi = \frac{{h}_{i} α {H}^{2}}{{k}_{s , eff}} , Biot number defined by Equation 26 ( h )$ |
| Biᵢₙₜ | ${Bi}_{int} = \frac{{h}_{int} H}{{k}_{s , eff}} , interface Biot number defined by Equation 26 ( i )$ |
| cₚ | specific heat of the fluid [J kg⁻¹ K⁻¹] |
| dₚ | particle diameter [m] |
| D₀ to D₉ | parameters calculated by Equations 51, 63 and 87 |
| Da | $Da = \frac{K}{{H}^{2}} , Darcy number$ |
| F | the geometric function defined by Equation 8 |
| hᵢ | interstitial heat transfer coefficient [W m⁻² K⁻¹] |
| hᵢₙₜ | interface heat transfer coefficient [W m⁻² K⁻¹] |
| h_{w} | wall heat transfer coefficient defined by Equation 81 [W m⁻² K⁻¹] |
| H | half height of the channel [m] |
| H₁ | half height of the porous media [m] |
| k | $k = \frac{{k}_{f , eff}}{{k}_{s , eff}} , ratio of the fluid effective thermal conductivity to that$ $of the solid$ |
| K | permeability [m²] |
| k₀ | ${k}_{0} = \frac{{k}_{f}}{{k}_{s}} , ratio of the fluid thermal conductivity to that of the solid$ |
| k₁ | ${k}_{1} = \frac{{k}_{f}}{{k}_{s , eff}} , ratio of the fluid thermal conductivity to the solid$ $effective thermal conductivity$ |
| k_{f} | thermal conductivity of the fluid [W m⁻¹ K⁻¹] |
| k_{f,eff} | effective thermal conductivity of the fluid [W m⁻¹ K⁻¹] |
| kₛ | thermal conductivity of the solid [W m⁻¹ K⁻¹] |
| k_{s,eff} | effective thermal conductivity of the solid [W m⁻¹ K⁻¹] |
| Nu | Nusselt number |
| p | pressure [N m⁻²] |
| Pr | Prandtl number of fluid |
| Re_{H} | ${Re}_{H} = - \frac{{ρ}_{f} HK}{{μ}_{f}^{2}} \frac{dp}{dx} , Reynolds number$ |
| Reₚ | ${Re}_{p} = \frac{{ρ}_{f} {u}_{p} {d}_{p}}{{μ}_{f}} , particle Reynolds number$ |
| qᵢ | heat flux at the interface [W m⁻²] |
| q_{w} | heat flux at the wall [W m⁻²] |
| Q₀ | dimensionless internal heat exchange between fluid and solid phases |
| | within the region of 0 ≦ η ≦ η₀ |
| Q₁ | dimensionless internal heat exchange between fluid and solid phases |
| | within the region of η₀ ≦ η ≦ η₁ |
| Qᵢₙₜ | dimensionless heat exchange between fluid and solid phases at the |
| | interface |
| T | temperature [K] |
| u | fluid velocity [m s⁻¹] |
| uₘ | area average velocity over the channel cross section [m s⁻¹] |
| U | $U = \frac{u}{- \frac{{H}^{2}}{{μ}_{f}} \frac{dp}{dx}} , dimensionless fluid velocity$ |
| U_{B} | dimensionless interface velocity |
| Uₘ | dimensionless average velocity over the channel cross section |
| x | longitudinal coordinate [m] |
| y | transverse coordinate [m] |
| Greek symbols | |
| α | interfacial area per unit volume of the porous medium [m⁻¹] |
| α* | velocity slip coefficient at the interface |
| ε | porosity |
| β | ratio of heat flux for the fluid phase to the total heat flux at the interface |
| η | $η = \frac{y}{H} , non \text{-} dimensional transverse coordinate$ |
| η₀ | dimensionless transverse location where the dimensionless temperature of |
| | fluid is equal to that of solid phase |
| n₁ | ${η}_{1} = \frac{{H}_{1}}{H} , non \text{-} dimensional half height of the porous media$ |
| θ | $θ = \frac{{k}_{s , eff} ( T - {T}_{s , i} )}{{q}_{w} H} , non \text{-} dimensional temperature , defined by Equation 26 ( a )$ |
| Δθₐ | average relative temperature difference between solid and fluid phases |
| Λ_{H} | ${Λ}_{H} = \frac{F ɛ H}{\sqrt{K}} , inertia parameter$ |
| μ | dynamic viscosity [kg m⁻¹ s⁻¹] |
| P | density [kg m⁻³] |
| γ | $γ = \frac{{q}_{i}}{{q}_{w}} , dimensionless heat flux at the interface$ |
| λ | λ = \sqrt{Bi(1 + k)/k}, parameter calculated by Equation 49 |
| ρ | fluid density [kg m⁻³] |
| Subscripts | |
| b | bulk mean value |
| cr | critical value |
| f | fluid |
| i | interface |
| open | open region |
| p | porous region |
| s | solid phase |
| w | wall |

### 1. Modeling and Formulation

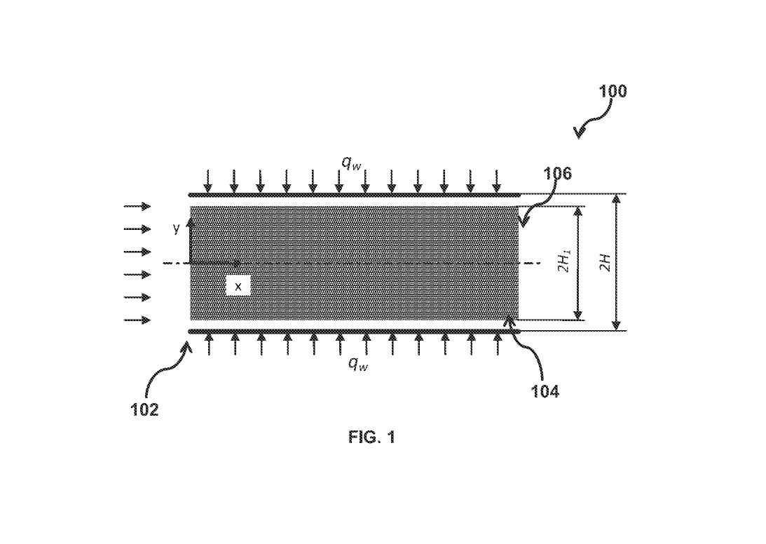

FIG. 1 illustrates a schematic diagram of a physical model and a corresponding coordinate system 100, in which fluid flows through a rectangular channel 102 partially filled with a porous medium 104 in the core region 106 and subject to a constant heat, q_{w}, in accordance with the disclosed embodiments. The height of the channel is 2H, and that of the porous medium is 2H₁. Constant fluid properties can be assumed. Velocity and temperature profiles can be considered to be fully developed, and the momentum equation for porous region 106 can be represented by a Darcian-Forchheimer model.

Based on these assumptions, governing conservation equations for the porous region, for example, can be obtained from the works of Amiri and Vafai based on the LTNE model. See A. Amiri, K. Vafai, Analysis of Dispersion Effects and Non-Thermal Equilibrium Non-Darcian, Variable Porosity Incompressible Flow Through Porous Medium, International Journal of Heat and Mass Transfer, 1994, 37: 939-954

### 1.1 Fluid Phase

$${k}_{f , eff} \frac{{\partial }^{2} {T}_{f}}{\partial {y}^{2}} + {h}_{i} α ( {T}_{s} - {T}_{f} ) = ρ {c}_{p} u \frac{\partial {T}_{f}}{\partial x} \qquad Eq . 1$$

### 1.2 Solid Phase

$${k}_{s , eff} \frac{{\partial }^{2} {T}_{s}}{\partial {y}^{2}} - {h}_{i} α ( {T}_{s} - {T}_{f} ) = 0 \qquad Eq . 2$$

wherein T_{f} and Tₛ denote the fluid and solid temperatures, k_{f,eff} and k_{s,eff} denote the effective fluid and solid thermal conductivities, u is the fluid velocity, ρ denotes the density of the fluid, cₚ denotes the specific heat of the fluid, hᵢ is the interstitial heat transfer coefficient, and α is the interfacial area per unit volume of the porous medium.

The effective thermal conductivities of both phases can be obtained as

k_{f,eff}=εk_{f} Eq. 3

k_{s,eff}=(1−ε)kₛ Eq. 4

wherein k_{f} and kₛ are the fluid and solid thermal conductivities, respectively.

When the thermal dispersion effect is accounted for, the effective thermal conductivities of fluid phases can be represented as in A. Amiri, K. Vafai.

k_{f,eff}=(ε+0.1PrReₚ)k_{f} Eq. 5

wherein Pr denotes the Prandtl number of fluid, Reₚ the particle Reynolds number,

$${Re}_{p} = \frac{{ρ}_{f} {u}_{p} {d}_{p}}{{μ}_{f}} \qquad Eq . 6$$

wherein dₚ denotes particle diameter and uₚ is the velocity in the porous medium.

The momentum equation in the porous region can be written as

$$- \frac{{μ}_{f}}{K} u - \frac{{ρ}_{f} F ɛ}{\sqrt{K}} {u}^{2} - \frac{d p}{d x} = 0 \qquad Eq . 7$$

wherein K denotes the permeability, μ_{f} is the fluid dynamic viscosity, ε is the porosity, ρ denotes the pressure, and F is the geometric function. Parameter F is obtained as in A. Amiri, K. Vafai.

$$F = \frac{1.75}{\sqrt{150 {ɛ}^{3}}} \qquad Eq . 8$$

The momentum and energy equations in the open region are

$$\begin{matrix}- \frac{d p}{d x} + {μ}_{f} \frac{{d}^{2} u}{d {y}^{2}} = 0 & Eq . 9 \\ {k}_{f} \frac{{\partial }^{2} {T}_{f}}{\partial {y}^{2}} = ρ {c}_{p} u \frac{\partial {T}_{f}}{\partial x} & Eq . 10\end{matrix}$$

The boundary conditions at the wall and the interface are

$$\begin{matrix}{\frac{\partial u}{\partial y} \vert}_{y = 0} = 0 & Eq . 11 \\ {{\frac{\partial {T}_{f}}{\partial y} \vert}_{y = 0} = \frac{\partial {T}_{s}}{\partial y} \vert}_{y = 0} = 0 & Eq . 12 \\ u {\vert}_{y = H} = 0 & Eq . 13 \\ {{k}_{f } \frac{\partial {T}_{f}}{\partial y} \vert}_{y = H} = {q}_{w} & Eq . 14 \\ {\frac{\partial u}{\partial y} \vert}_{y = {H}_{1}^{+}} = \frac{{α}^{*}}{\sqrt{K}} ( {u}_{B} - {u}_{p} ) & Eq . 15\end{matrix}$$

wherein u_{B} denotes the interface velocity and a* is the velocity slip coefficient, and the slip velocity condition at the interface between the open and porous regions based on Beavers and Joseph model is adopted here. See G. S. Beavers, D. D. Joseph, Boundary conditions at a naturally permeable wall, J. Fluid Mech. 1967, 30(1): 197-207. In this work, we utilize three models to describe the thermal interface conditions at the fluid-porous interface. These are models A, B and C.

### 1.3 Model A

If the heat transfer between fluid and solid phases at the interface is very substantial, then the temperatures of both phases can be considered to be equal. This constitutes Model A. That is

$$\begin{matrix}{{{{T}_{f} \vert}_{y = {H}_{1}^{-}} = {T}_{s} \vert}_{y = {H}_{1}^{-}} = {T}_{f} \vert}_{y = {H}_{1}^{+}} & Eq . 16 \\ {{{{k}_{f , eff} \frac{\partial {T}_{f}}{\partial y} \vert}_{y = {H}_{1}^{-}} + {k}_{s , eff} \frac{\partial {T}_{s}}{\partial y} \vert}_{y = {H}_{1}^{-}} = {k}_{f} \frac{\partial {T}_{f}}{\partial y} \vert}_{y = {H}_{1}^{+}} = {q}_{i} & Eq . 17\end{matrix}$$

wherein q is the total heat flux at the interface.

### 1.4 Model B

When the heat transfer between the fluid and solid phases at the interface is not strong enough, the fluid and solid temperatures at the interface will not be equal. As such, the total heat flux distribution between the solid and fluid phases at the interface is evaluated by an interface thermal parameter, β. This is the basis for Model B.

$$\begin{matrix}{{T}_{f} {\vert}_{y = {H}_{1}^{-}} = {T}_{f} \vert}_{y = {H}_{1}^{+}} & Eq . 18 \\ {{k}_{f} \frac{\partial {T}_{f}}{\partial y} \vert}_{y = {H}_{1}^{+}} = {q}_{i} & Eq . 19 \\ {{k}_{f , eff} \frac{\partial {T}_{f}}{\partial y} \vert}_{y = {H}_{1}^{-}} = β {q}_{i} & Eq . 20 \\ {{k}_{s , eff} \frac{\partial {T}_{s}}{\partial y} \vert}_{y = {H}_{1}^{-}} = ( 1 - β ) {q}_{i} & Eq . 21\end{matrix}$$

wherein β is the ratio of heat flux for the fluid phase to the total heat flux at the interface.

### 1.5 Model C

The temperatures of fluid and solid phases are also not equal at the interface for Model C, and the heat exchange between fluid and solid phases at the interface is calculated by introducing an interface heat transfer coefficient, hᵢₙₜ, based on the heat flux jump interfacial condition developed by Ochoa-Tapia and Whitaker. See J. A. Ochoa-Tapia, S. Whitaker, Heat transfer at the boundary between a porous medium and a homogeneous fluid, Int. J. Heat Mass Transfer, 1997, 40(11): 2691-2707.

$$\begin{matrix}{{T}_{f} \vert}_{y = {H}_{1}^{-}} = {T}_{f} {\vert}_{y = {H}_{1}^{+}} & Eq . 22 \\ {{k}_{f} \frac{\partial {T}_{f}}{\partial y} \vert}_{y = {H}_{1}^{+}} = {q}_{i} & Eq . 23 \\ {{k}_{f , eff} \frac{\partial {T}_{f}}{\partial y} \vert}_{y = {H}_{1}^{-}} = {q}_{i} - {{h}_{int} ( {T}_{f} \vert}_{y = {H}_{1}^{-}} - {T}_{s} {\vert}_{y = {H}_{1}^{-}} ) & Eq . 24 \\ {{{k}_{s , eff} \frac{\partial {T}_{s}}{\partial y} \vert}_{y = {H}_{1}^{-}} = {{h}_{int} ( {T}_{f} \vert}_{y = {H}_{1}^{-}} - {T}_{s} \vert}_{y = {H}_{1}^{-}} ) & Eq . 25\end{matrix}$$

wherein hᵢₙₜ is the interface heat transfer coefficient.

The following non-dimensional variables have been introduced

$$\begin{matrix}θ = \frac{{k}_{s , eff} ( T - {T}_{s , i} )}{{q}_{w} H} & Eq . 26 ( a ) \\ η = \frac{y}{H} & Eq . 26 ( b ) \\ {η}_{1} = \frac{{H}_{1}}{H} & Eq . 26 ( c ) \\ γ = \frac{{q}_{i}}{{q}_{w}} & Eq . 26 ( d ) \\ {k}_{0} = \frac{{k}_{f}}{{k}_{s }} & Eq . 26 ( e ) \\ k = \frac{{k}_{f , eff}}{{k}_{s , eff}} & Eq . 26 ( f ) \\ {k}_{1} = \frac{{k}_{f}}{{k}_{s , eff}} & Eq . 26 ( g ) \\ Bi = \frac{{h}_{i} α {H}^{2}}{{k}_{s , eff}} & Eq . 26 ( h ) \\ {Bi}_{int} = \frac{{h}_{int} H}{{k}_{s , eff}} & Eq . 26 ( i ) \\ Da = \frac{K}{{H}^{2}} & Eq . 26 ( j ) \\ U = \frac{u}{- \frac{{H}^{2}}{{μ}_{f}} \frac{d p}{d x}} & Eq . 26 ( k ) \\ {Λ}_{H} = \frac{F ɛ H}{\sqrt{K}} & Eq . 26 ( l ) \\ {Re}_{H} = - \frac{{ρ}_{f} HK}{{μ}_{f}^{2}} \frac{d p}{d x} & Eq . 26 ( m )\end{matrix}$$

wherein T_{s,I} is the temperature of solid phase at the interface.

Adding governing Equations 1 and 2, the following equation is obtained

$${k}_{f , eff} \frac{{\partial }^{2} {T}_{f}}{\partial {y}^{2}} + {k}_{s , eff} \frac{{\partial }^{2} {T}_{s}}{\partial {y}^{2}} = ρ {c}_{p} u \frac{\partial {T}_{f}}{\partial x} \qquad Eq . 27$$

Integrating Equation 27 from the center to the fluid-porous interface and applying the corresponding boundary Equation 15 and interface Equation 17 for Model A, or Equations 20 and 21 for Model B, or Equations 24 and 25 for Model C, result in

$$ρ {c}_{p} {u}_{p} \frac{\partial {T}_{f}}{\partial x} = \frac{{q}_{i}}{{H}_{1}} \qquad Eq . 28$$

A similar equation is obtained by integrating the energy Equation 10 in open region from the interface to the wall and using the corresponding boundary and interface conditions

$$ρ {c}_{p} {u}_{m , open} \frac{\partial {T}_{f}}{\partial x} = \frac{{q}_{w} - {q}_{i}}{H - {H}_{1}} \qquad Eq . 29$$

wherein u_{m,open} is the average fluid velocity in the open region.

Based on the momentum Equations 7 and 9 and the corresponding boundary and interface Equations 11, 13, and 15, the velocity distributions are obtained as

In the porous region:

U=Uₚ 0≦η≦η₁ Eq. 30

wherein Uₚ denotes the dimensionless velocity in porous medium.

$${U}_{p} = \frac{- 1 + \sqrt{1 + 4 Da {Λ}_{H} {Re}_{H}}}{2 {Λ}_{H} {Re}_{H}} \qquad Eq . 31$$

In the open region:

$$U = - 0.5 {( η - {η}_{1} )}^{2} + \frac{{α}^{*}}{\sqrt{Da}} ( {U}_{B} - {U}_{p} ) ( η - {η}_{1} ) + {U}_{B} \\ {η}_{1} < η \leq 1 \qquad Eq . 32$$

wherein U_{B} is the dimensionless interface velocity

$${U}_{B} = \frac{0.5 {( 1 - {η}_{1} )}^{2} + \frac{{α}^{*}}{\sqrt{Da}} {U}_{p} ( 1 - {η}_{1} )}{1 + \frac{{α}^{*}}{\sqrt{Da}} ( 1 - {η}_{1} )} \qquad Eq . 33$$

Based on Equation 32, the dimensionless average velocity in the open region is obtained as

$${U}_{m , open} = - \frac{1}{6} {( 1 - {η}_{1} )}^{2} + \frac{{α}^{*}}{2 \sqrt{Da}} ( {U}_{B} - {U}_{p} ) ( 1 - {η}_{1} ) + {U}_{B} \qquad Eq . 34$$

Based on Equations 31 and 34, the dimensionless average velocity over the channel cross section is obtained as

Uₘ=η₁Uₚ+(1−η₁)U_{m,open} Eq. 35

Based on Equations 28-30, 34, and 35, the dimensionless total heat flux at the interface can be obtained as

$$γ = \frac{{q}_{i}}{{q}_{w }} = \frac{{η}_{1} {U}_{p}}{{U}_{m}} \qquad Eq . 36$$

### 1.5.1 Temperature Solution for Interface Thermal Condition of Model A

The energy governing equations and the corresponding boundary and interface conditions for Model A are normalized by using Emotions 26(a-m) and 30-36

$$\begin{matrix}k \frac{{\partial }^{2} {θ}_{f}}{\partial {η}^{2}} + Bi ( {θ}_{s} - {θ}_{f} ) = \frac{γ}{{η}_{1}} \\ 0 \leq η \leq {η}_{1} & Eq . 37 \\ \frac{{\partial }^{2} {θ}_{s}}{\partial {η}^{2}} - Bi ( {θ}_{s} - {θ}_{f} ) = 0 \\ 0 \leq η \leq {η}_{1} & Eq . 38 \\ {k}_{1} \frac{{\partial }^{2} {θ}_{f}}{\partial {η}^{2}} = \frac{U}{{U}_{m }} \\ {η}_{1} < η \leq 1 & Eq . 39 \\ {{\frac{\partial {θ}_{f}}{\partial η} \vert}_{η = 0} = \frac{\partial {θ}_{s}}{\partial η} \vert}_{η = 0} = 0 & Eq . 40 \\ {{{{θ}_{f} \vert}_{η = {η}_{1}^{-}} = {θ}_{s} \vert}_{η = {η}_{1}^{-}} = {θ}_{f} \vert}_{η = {η}_{1}^{+}} = 0 & Eq . 41 \\ {\frac{\partial {θ}_{f}}{\partial η} \vert}_{η = 1} = \frac{1}{{k}_{1}} & Eq . 42\end{matrix}$$

Based on Equations 37 and 38, the governing equations for fluid and solid phases in the porous region are obtained as

$$\begin{matrix} k \text{?} - ( 1 + k ) Bi \text{?} = - Bi \frac{γ}{{η}_{1}} & Eq . 43 \\ k \text{?} - ( 1 + k ) Bi \text{?} = - Bi \frac{γ}{{η}_{1}} \\ \text{?} \text{indicates text missing or illegible when filed} & Eq . 44\end{matrix}$$

Differentiating Equations 37 and 38 and utilizing the boundary and interface Equations 40 and 41, the following equations are obtained.

$$\begin{matrix} \text{?} ( {η}_{1}^{-} ) = \frac{γ}{{η}_{1} k} \\ {θ}_{s}^{″} ( {η}_{1}^{-} ) = 0 & Eq . 45 \\ \text{?} ( 0 ) = \text{?} ( 0 ) = 0 \\ \text{?} \text{indicates text missing or illegible when filed} & Eq . 46\end{matrix}$$

Solving Equations 43 and 44 and applying the boundary Equations 40, 41, 45, and 46, the temperature distribution in the porous region is obtained as

$$\begin{matrix}{θ}_{f} = \frac{γ}{( 1 + k ) {η}_{1}} \{ \frac{1}{2} ( {η}^{2} - {η}_{1}^{2} ) + \frac{1}{( 1 + k ) Bi} [ \frac{cosh ( λ η )}{cosh ( λ {η}_{1} )} - 1 ] \} & Eq . 47 \\ {θ}_{s} = \frac{γ}{( 1 + k ) {η}_{1}} \{ \frac{1}{2} ( {η}^{2} - {η}_{1}^{2} ) + \frac{k}{( 1 + k ) Bi} [ 1 - \frac{cosh ( λ η )}{cosh ( λ {η}_{1} )} ] \} & Eq . 48 \\ wherein λ = \sqrt{Bi ( 1 + k ) / k} & Eq . 49\end{matrix}$$

Solving Equation 39 and applying the boundary Equations 41 and 42, the temperature distribution in the open region is obtained as

$$\begin{matrix}{θ}_{f} = {{D}_{0} ( η - {η}_{1} )}^{4} + {{D}_{1} ( η - {η}_{1} )}^{3} + {{D}_{2} ( η - {η}_{1} )}^{2} + {D}_{3} ( η - {η}_{1} ) & Eq . 50 \\ where {D}_{0} = - \frac{1}{24 {U}_{m} {k}_{1}} & Eq . 51 \\ {D}_{1} = \frac{{α}^{*}}{6 {U}_{m} {k}_{1} \sqrt{Da}} ( {U}_{B} - {U}_{p} ) & Eq . 52 \\ {D}_{2} = \frac{{U}_{B}}{2 {U}_{m} {k}_{1}} & Eq . 53 \\ {D}_{3} = \frac{1}{{k}_{1}} - 4 {{D}_{0} ( 1 - {η}_{1} )}^{3} - 3 {{D}_{1} ( 1 - {η}_{1} )}^{2} - 2 {D}_{2} ( 1 - {η}_{1} ) & Eq . 54\end{matrix}$$

### 1.6 Temperature Solution For Interface Thermal Condition Of Model B

The interface thermal conditions for Model B are normalized as

$$\begin{matrix}{{θ}_{s} \vert}_{η = {η}_{1}^{-}} = 0 & Eq . 52 \\ {\frac{\partial {θ}_{f}}{\partial η} \vert}_{η = {η}_{1}^{-}} = \frac{βγ}{k} & Eq . 53 \\ {{{θ}_{f} \vert}_{η = {η}_{1}^{-}} = {θ}_{f} \vert}_{η = {η}_{1}^{+}} & Eq . 54\end{matrix}$$

Solving governing Equations 37, 38 and 39 and applying the boundary and interface Equations 40, 42, 52, 53 and 54, the temperature distributions are obtained as

In the porous region:

$$\begin{matrix}{θ}_{f} = \frac{γ}{( 1 + k ) λ sinh ( λ {η}_{1} )} [ β - k ( 1 - β ) ] [ \frac{cosh ( λ η )}{k} + cosh ( λ {η}_{1} ) ] + \frac{γ ( {η}^{2} - {η}_{1}^{2} )}{2 {η}_{1} ( 1 + k )} - \frac{γ}{( 1 + k ) {η}_{1} Bi} & Eq . 55 \\ {θ}_{s} = \frac{γ}{( 1 + k ) λ sinh ( λ {η}_{1} )} [ β - k ( 1 - β ) ] [ cosh ( {λη}_{1} ) - cosh ( λη ) ] + \frac{γ ( {η}^{2} - {η}_{1}^{2} )}{2 {η}_{1} ( 1 + k )} & Eq . 56\end{matrix}$$

In the open region:

θ_{f}=D₀(η−η₁)⁴ +D₁(η−η₁)³+D₂(η−η₁)²+D₃(η−η₁)+θ_{f} (η₁⁻) Eq. 57

where θ_{f}(η₁⁻) is calculated using Equation 55, D₀, D₁, D₂, and D₃ are calculated using Equation 51.

### 1.7 Temperature Solution For Interface Thermal Condition Of Model C

The interface thermal conditions for Model C are normalized as

$$\begin{matrix}{θ}_{s} {\vert}_{η = {η}_{1}^{-}} = 0 & Eq . 58 \\ {k \frac{\partial {θ}_{f}}{\partial η} \vert}_{η = {η}_{1}^{-}} = γ - {Bi}_{int} ( {θ}_{f} {{\vert}_{η = {η}_{1}^{-}} - {θ}_{s} \vert}_{η = {η}_{1}^{-}} ) & Eq . 59 \\ {θ}_{f} {\vert}_{η = {η}_{1}^{-}} = {θ}_{f} {\vert}_{η = {η}_{1}^{+}} & Eq . 60\end{matrix}$$

Solving governing Equations 37, 38 and 39 and applying the boundary and interface Equations 40, 42, 58, 59 and 60, the temperature solutions are obtained as

In porous region:

$$\begin{matrix}{θ}_{f} = \frac{γ {D}_{4}}{{λ}^{2} {η}_{1}} cosh ( λη ) + \frac{γ {η}^{2}}{2 {η}_{1} ( 1 + k )} + γ {η}_{1} {D}_{5} & Eq . 61 \\ {θ}_{s} = \frac{γ {D}_{6}}{{λ}^{2} {η}_{1}} cosh ( λ η ) + \frac{γ {η}^{2}}{2 {η}_{1} ( 1 + k )} + γ {η}_{1} {D}_{7} \\ where \\ {D}_{4} = \frac{Bi {η}_{1} + {Bi}_{int}}{λ {k}^{2} sinh ( λ {η}_{1} ) + {Bi}_{int} k ( 1 + k ) cosh ( λ {η}_{1} )} \\ {D}_{5} = \frac{{D}_{4} {k}^{2}}{Bi {η}_{1}^{2} ( 1 + k )} cosh ( λ {η}_{1} ) - \frac{1}{Bi {η}_{1}^{2} ( 1 + k )} - \frac{1}{2 ( 1 + k )} \\ {D}_{6} = \frac{{D}_{8} {Bi}_{int} {η}_{1} ( 1 + k ) - 1}{sinh ( λ {η}_{1} ) ( 1 + k )} λ {η}_{1} \\ {D}_{7} = - \frac{{D}_{6}}{{λ}^{2} {η}_{1}^{2}} cosh ( λ {η}_{1} ) - \frac{1}{2 ( 1 + k )} & Eq . 62 \\ {D}_{8} = \frac{{D}_{4}}{{λ}^{2} {η}_{1}^{2}} cosh ( λ {η}_{1} ) + \frac{1}{2 ( 1 + k )} + {D}_{5} & Eq . 63\end{matrix}$$

In open region:

θ_{f}=D₀(η−η₁)⁴+D₁(η−η₁)³+D₂(η−η₁)²+D₃(η−η₁)+θ_{f}(η₁⁻) Eq. 64

where θ_{f}(η₁⁻) is calculated using Equation 61, D₀, D₁, D₂, and D₃ are calculated using Equation 51.

### 2. Results And Discussion

### 2.1 Validity of the Interface Thermal Models

The dimensionless fluid phase temperature should be larger than the dimensionless solid phase temperature at the interface based on the second law of thermodynamics. That is

θ_{f}|_{η=η}_{₁}_{^{−}}≧θₛ|_{η=η}_{₁}_{^{−}} Eq. 65

Also, the dimensionless temperature gradient of the solid phase at the interface should be larger than zero. That is

$${\frac{\partial {θ}_{s}}{\partial η} \vert}_{η = {η}_{1}^{-}} \geq 0 \qquad Eq . 66$$

Substituting Equations 61 and 62 in Equations 65 and 66, results in

Biᵢₙₜ≧0 Eq. 67

Substituting Equations 55 and 56 in Equation 65 and 66, results in

1≧β≧β_{cr} Eq. 68

wherein β_{cr} denotes critical ratio of heat flux for the fluid phase to the total heat flux at the interface. Based on Equation 68, β_{cr} stands for the minimum ratio of heat flux for the fluid phase to the total heat flux at the interface. Based on Equations 20 and 21, the maximum ratio of heat flux for the solid phase to the total heat flux at the interface is equal to 1-β_{cr}.

$${β}_{cr} = \frac{\frac{sinh ( λ {η}_{1} )}{λ {η}_{1} cosh ( λ {η}_{1} )} + k}{1 + k} \qquad Eq . 69$$

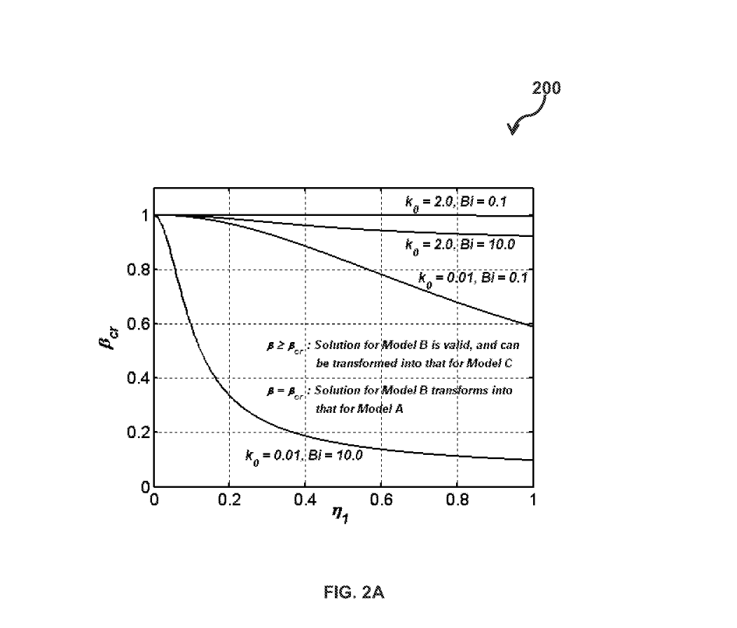

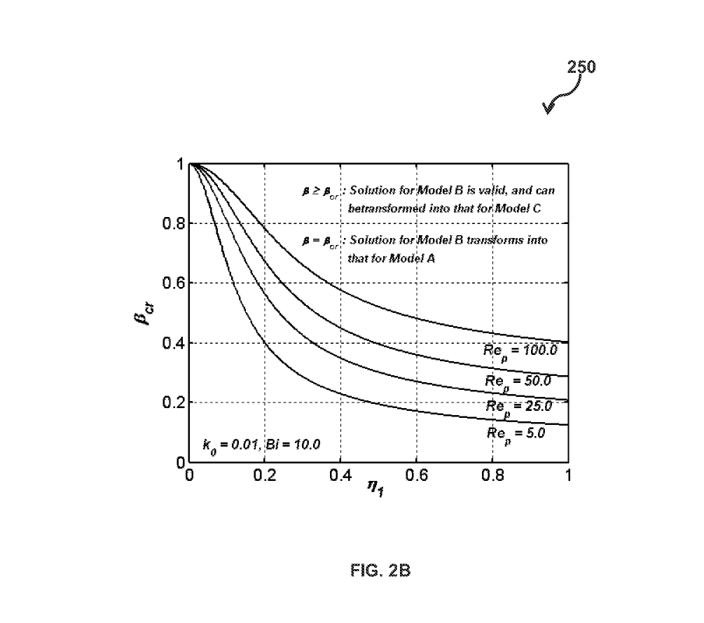

The distributions of critical heat flux ratio β_{cr} for different parameters Bi, k₀ and Reₚ are shown as graphs 200 and 250 in FIG. 2A and FIG. 2B. It is found from Equation 69 that β_{cr} increases as k becomes larger or η₁ and Bi become smaller. Therefore, when the thermal dispersion effect is excluded, β_{cr} increases as k₀ becomes larger since k increases with k₀, as shown in FIG. 2A. When the thermal dispersion effect is incorporated, β_{cr} increases as Reₚ becomes larger since k increases with Reₚ, as shown in FIG. 2B. When k is large and Bi is small, β_{cr} will increases up to about 1, which means most of the total heat flux at the interface should be transferred into porous region through the fluid phase.

### 2.2 Equivalence Correlations Between Each Interface Thermal Model

An important physical feature is found by comparing the temperature solutions for different interface thermal models. These solutions become equivalent to each other under the following conditions when β=β_{cr}, the temperatures of fluid and solid phases at the interface are equal, thus the solution for Model B is equivalent to that for Model A, when β=1-D₈Biᵢₙₜη₁, the solution for Model B is equivalent to that for Model C, when Biᵢₙₜ →∞, the temperatures of fluid and solid phases at the interface are equal, thus the solution for Model C is equivalent to that for Model A, when Bᵢₙₜ→0, there is no heat exchange between fluid and solid phases at the interface, thus the solution for Model C is equivalent to that for Model B for β=1.

### 2.3 Temperature Distributions And Heat Flux Bifurcation Phenomenon

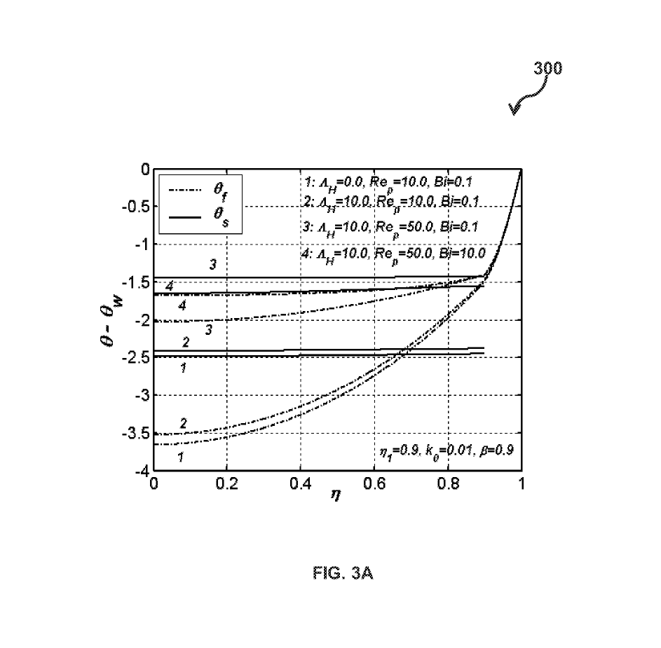

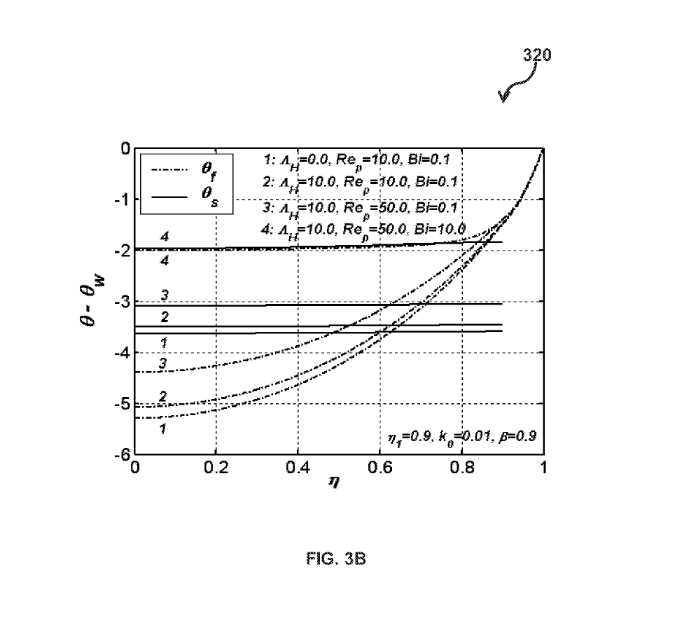

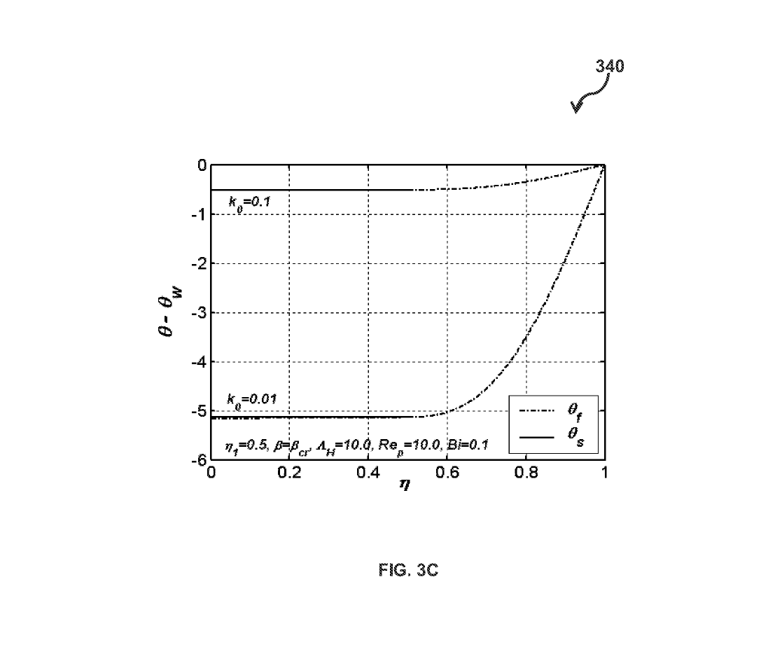

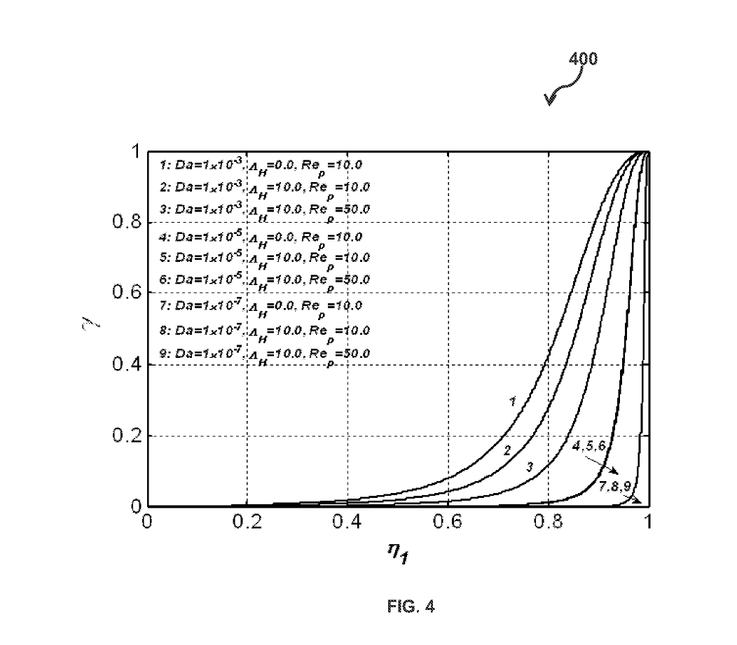

FIGS. 3A-3C shows graphs 300, 320, and 340 of dimensionless temperature distributions as a function of η₁, k₀, β, Reₚ, Λ_{H}, and Bi. When Λ_{H}=0, the inertia effect is excluded, otherwise, the inertia effect is incorporated. The temperature difference between the fluid and the channel wall is found to decreases while the inertia and the thermal dispersion effects are incorporated. This temperature difference also decreases when Reₚ and Bi increase. When Bi is small, which translates into a weak internal heat transfer between the fluid and solid phases, the temperature difference between the two phases is relatively large. However, when η₁ is small, the temperature difference between the two phases is quite small, even for a small Bi, as shown in FIG. 3C. This is because, when η₁ is small, the total heat flux at the interface is also small, as shown in FIG. 4. Since only a small amount of heat flux will be transferred through the porous region, the influence of Bi can be negligible. FIG. 4 illustrates a graph 400 showing the variations of total heat flux at the interface as a function of pertinent parameters Λ_{H}, Reₚ, and Da. It is found that the total heat flux at the interface decreases while the inertia effect is incorporated, and decreases as Reₚ becomes larger or Da and η₁ becomes smaller. However, when Da is smaller than 10⁻⁵, the influence of Reₚ and Λ_{H} can be neglected. When η₁ is smaller than 0.4, the heat flux transferred into the porous region is so insignificant that the influence of Reₚ and Λ_{H} can be neglected. Furthermore, it can be found from Equation 36 that, when the inertia effect is excluded, the total heat flux at the interface is independent of Reₚ.

It is important to note that the direction of heat exchange between the fluid and solid phases are different in two regions inside the porous medium, as shown in FIGS. 3A and 3B. This leads to a heat flux bifurcation for those cases. The condition for this phenomenon can be derived as

1≧β>β_{cr} Eq. 70

Based on the equivalence correlation between Model B and Model C, Equation 70 can be rewritten as

0£ Biᵢₙₜ<· Eq. 71

Equation 71 shows that, when the interface heat transfer coefficient does not approach infinity, the phenomenon of heat flux bifurcation will occur inside the two regions, 0≦η≦η₀ and η₀ <η≦η₁. Within the region of η₀<η≦η₁, the dimensionless temperature of fluid phase is larger than that of the solid phase, while within the region of 0≦η≦η₀, the dimensionless temperature of fluid phase is smaller than that of the solid phase. The value of η₀ can be obtained by setting the temperatures of fluid and solid phases to be equal. Based on Equations 55 and 56, it is found that

$${η}_{0} = \frac{1}{λ} a cosh \{ \frac{sinh ( λ {η}_{1} )}{λ {η}_{1} [ β - k ( 1 - β ) ]} \} \qquad Eq . 72$$

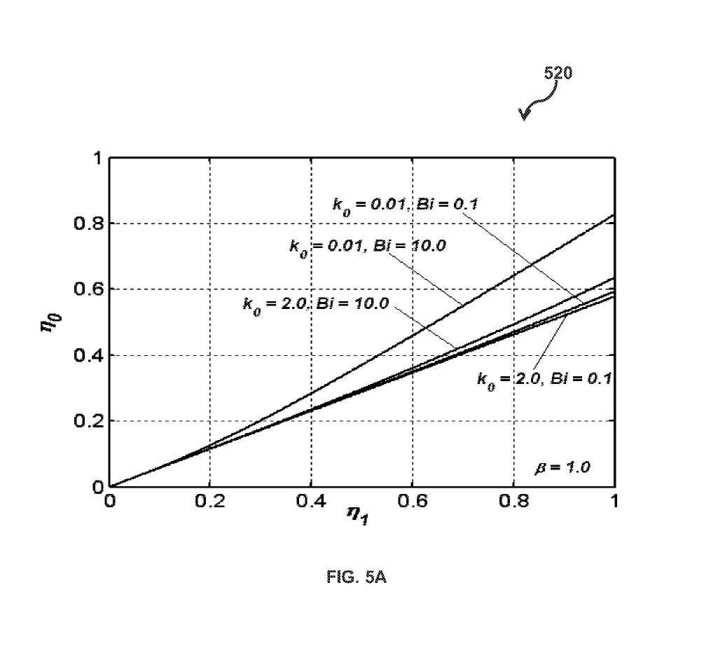

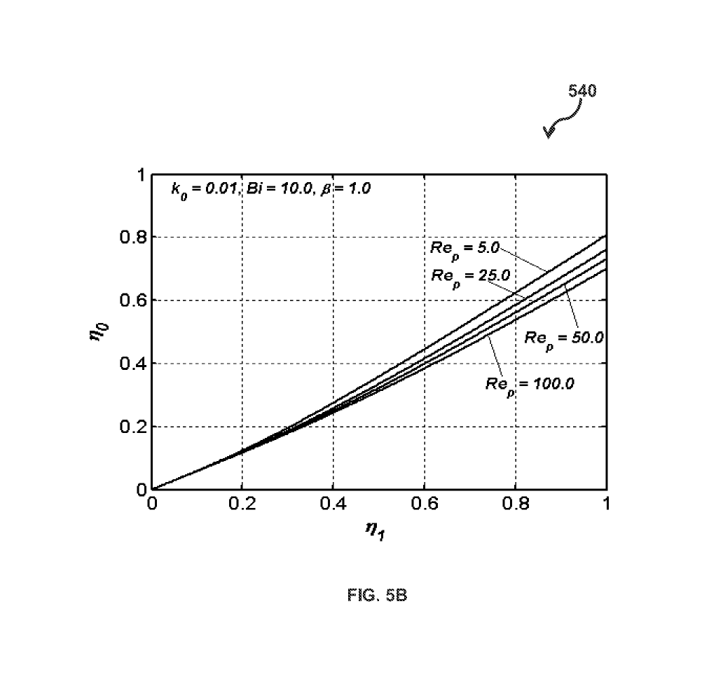

It is found from Equation 72 that η₀ increases as β becomes smaller. When β approaches β_{cr}, η₀ will approach η₁. The distributions of η₀ for pertinent parameters Bi, k₀, and Reₚ are shown in FIGS. 5A and 5B as graphs 520 and 540. When the thermal dispersion effect is excluded and β=1, η₀ increases as k₀ becomes smaller or Bi becomes larger, as shown in FIG. 5A. When the thermal dispersion effect is incorporated and β=1, η₀ increases as Reₚ becomes smaller, as shown in FIG. 5B.

The dimensionless internal heat exchange between fluid and solid phases within the region of 0≦η≦η₀ is obtained as

$${Q}_{0} = {\int }_{0}^{{η}_{0}} Bi ( {θ}_{f} - {θ}_{s} ) d η = \frac{γ}{1 + k} \{ [ β - k ( 1 - β ) ] \frac{sinh ( λ {η}_{0} )}{sinh ( λ {η}_{1} )} - \frac{{η}_{0}}{{η}_{1}} \} \qquad Eq . 73$$

The dimensionless internal heat exchange between fluid and solid phases within the region of η₀<η≦η₁ is obtained as

$${Q}_{1} = {\int }_{{η}_{0}}^{{η}_{1}} Bi ( {θ}_{f} - {θ}_{s} ) d η = \frac{γ}{1 + k} \{ [ β - k ( 1 - β ) ] ( 1 - \frac{sinh ( λ {η}_{0} )}{sinh ( λ {η}_{1} )} ) - ( 1 - \frac{{η}_{0}}{{η}_{1}} ) \} \qquad Eq . 74$$

The dimensionless heat exchange between fluid and solid phases at the interface is obtained as

Qᵢₙₜ=Biᵢₙₜ(θ_{f}−θₛ)_{η=η}_{₁}=(1−β)γ Eq. 75

Based on Equations 74-76, the following equation is obtained

Q₀+Q₁+Qᵢₙₜ=0 Eq. 76

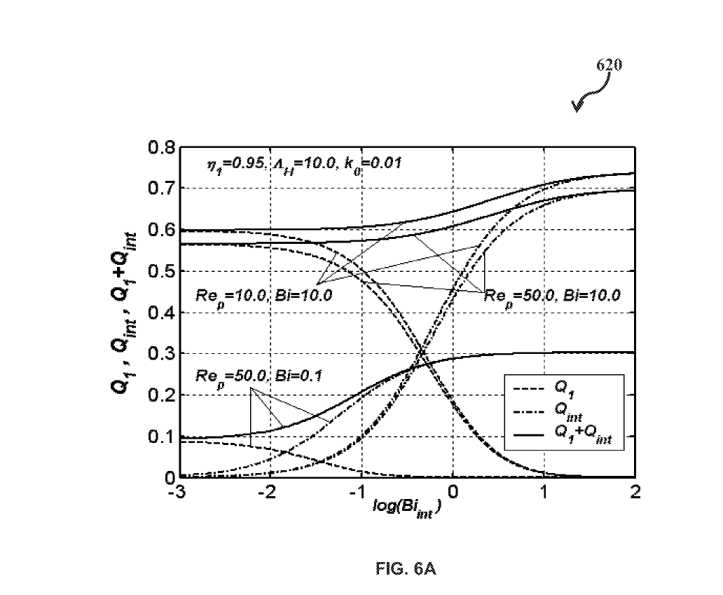

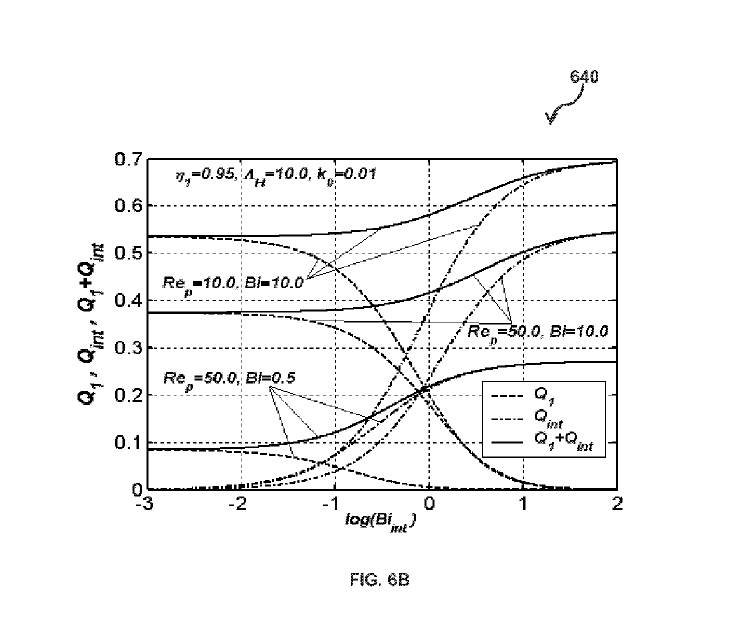

It should be noted that the parameters Q₁ and Qᵢₙₜ are always equal to or larger than zero, and the parameter Q₀ is always equal to or less than zero. The value Q₁+Qᵢₙₜ represents the total heat energy transferred from the fluid to the solid phase within the region of η₀<η≦η₁ and interface, which will be transferred back to fluid phase within the region of 0≦η≦η₀ based on Equation 76. The distributions of Q₁, Qᵢₙₜ, and Q₁+Qᵢₙₜ for pertinent parameters Reₚ, Bi, and Biᵢₙₜ are shown as graphs 620 and 640 in FIGS. 6A and 6B. It is found that Bi and Biᵢₙₜ are the major parameters that affect Q₁ and Qᵢₙₜ. Q₁ decreases with Biᵢₙₜ, and Qᵢₙₜ and Q₁+Qᵢₙₜ increase with Biᵢₙₜ. The figure also shows that, when the heat flux bifurcation occurs, the total heat energy transferred from the fluid to the solid phase within the region of η₀<η≦η₁ and interface will decrease. When Biᵢₙₜ is small, Q₁ is larger than Qᵢₙₜ; when Biᵢₙₜ is large, Qᵢₙₜ is larger than Qi. When Biᵢₙₜ approaches zero, Q₁ will approach a maximum value and Qᵢₙₜ will approach zero. However, when Biᵢₙₜ approaches infinity, Q₁ will approach zero, and Qᵢₙₜ and Q₁+Qᵢₙₜ will approach a maximum value. When Biᵢₙₜ is very small or large, the variations of Q₁, Qᵢₙₜ and Q₁+Qᵢₙₜ with Biᵢₙₜ are negligible. However, for intermediate values of Biᵢₙₜ, the variations of Q₁, Qᵢₙₜ and Q₁+Qᵢₙₜ with Biᵢₙₜ are quite substantial. It can also be seen that Q₁, Qᵢₙₜ and Q₁+Qᵢₙₜ increase as Reₚ becomes smaller, or for larger values of Bi.

### 2.4 LTE Condition

The average relative temperature difference between solid and fluid phases within the porous region is calculated as follows:

$$Δ {θ}_{a} = \frac{{\int }_{0}^{{η}_{1}} \vert {θ}_{f} - {θ}_{s} \vert d η}{{{( {θ}_{f} \vert}_{n = 1} - {θ}_{f} \vert}_{η = 0} ) {η}_{1}} = \frac{{Q}_{1} - {Q}_{0}}{( {θ}_{f} {\vert}_{n = 1} - {θ}_{f} {\vert}_{η = 0} ) {B}_{i} {η}_{1}} \qquad Eq . 77$$

It should be noted that, because of the occurrence of the heat flux bifurcation phenomenon, the average relative temperature difference between solid and fluid phases within the porous region cannot be calculated as follow:

$$Δ {θ}_{a \_ 1} = \frac{{\int }_{0}^{{η}_{1}} ( {θ}_{f} - {θ}_{s} ) d η}{( {θ}_{f} {\vert}_{η = 1} - {θ}_{f} {\vert}_{η = 0} ) {η}_{1}} = \frac{{Q}_{1} + {Q}_{0}}{( {θ}_{f} {\vert}_{η = 1} - {θ}_{f} {\vert}_{η = 0} ) {B}_{i} {η}_{1}} = \frac{- {Q}_{int}}{( {θ}_{f} {\vert}_{η = 1} - {θ}_{f} {\vert}_{η = 0} ) {B}_{i} {η}_{1}} \qquad Eq . 78$$

Otherwise, when Biᵢₙₜ approaches zero, Qᵢₙₜ will approach zero, thus the average relative temperature difference calculated according to Equation 78 will approach zero, which is obviously unreasonable.

When Δθₐ is small enough, the LTE condition is considered to be valid. In this work, the criterion for LTE condition is chosen to be Δθₐ<2%. Based on Equation 77, Δθₐ is found to decrease as η₁ becomes smaller. Therefore, a critical η_{1,cr} can be introduced to examine the LTE condition. That is, when η₁>η_{1,cr}, Δθₐ>2.0%, thus the LTE condition is considered to be invalid, when η₁<η_{1,cr}, Δθₐ<2.0%, thus the LTE condition is considered to be valid, wherein η_{1,cr} is determined based on the following equation

Δθ_{α}|_{η=η}_{_{1,cr}}=2.0% Eq. 79

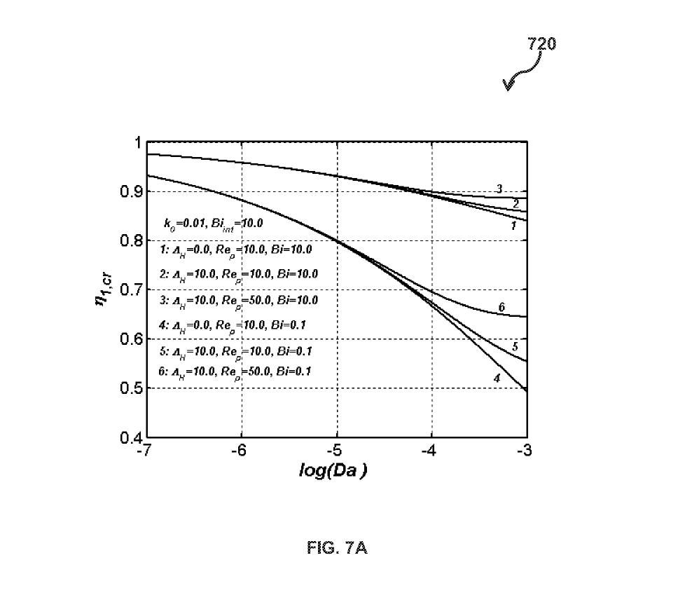

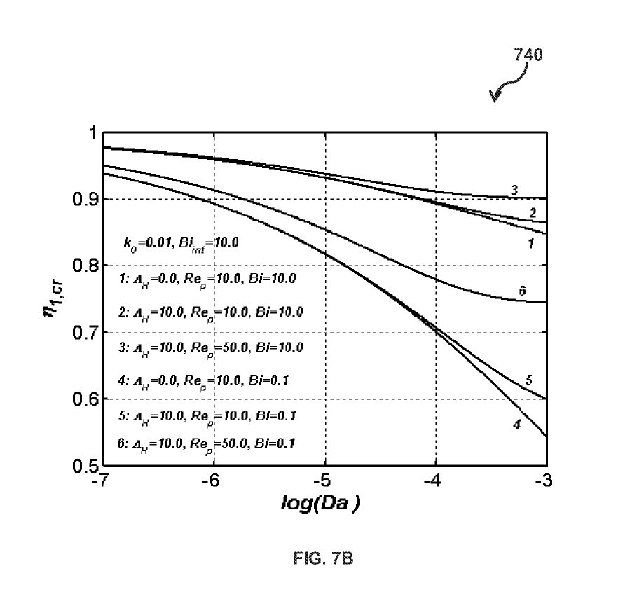

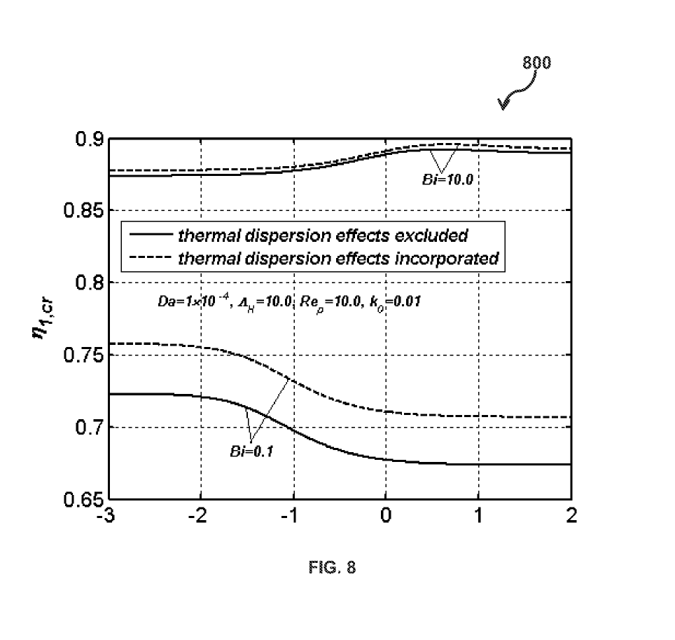

The η_{1,cr} variations as a function of pertinent parameters Bi, Biᵢₙₜ, Reₚ, Λ_{H}, and Da are depicted in FIGS. 7A and 7B as graphs 720 and 740 and in FIG. 8 as graph 800, in accordance with the disclosed embodiments. It is found that η_{1,cr} increases as Da becomes smaller, or Reₚ become larger, or the inertia effect is incorporated, which is the result of the decrease in the total heat flux transferred into the porous region, as shown in FIG. 4. It is also found that η_{1,cr} increases as Bi becomes larger, since a larger Bi can be translated into a strong internal heat transfer between the fluid and solid phases. However, when η₁ is small enough, the LTE condition is valid, even for a small Bi. This is because the total heat flux transferred into the porous region decreases as η₁ becomes smaller, as illustrated in FIG. 4.

Comparing between FIGS. 7A and 7B, it is found that, when the thermal dispersion effect is incorporated, η_{1,cr} will increase, which also can be seen in FIG. 8. This is because the dispersion phenomenon is treated as an additional diffusive term for the effective conductivity of fluid phase based on Equation 5. FIG. 8 reveals that Biᵢₙₜ has a complicated influence on the η_{1,cr} distributions. When Bi is small, η_{1, cr} will increase as Biᵢₙₜ becomes smaller. However, when Bi is large, η_{1,cr} will reach its maximum value at moderate values of Biᵢₙₜ.

### 2.5 Nusselt Number Results

The non-dimensional bulk mean temperature of the fluid can be calculated as

$${θ}_{f , b} = \frac{{\int }_{0}^{1} {θ}_{f} ( η ) U d η}{{U}_{m}} \qquad Eq . 80$$

The wall heat transfer coefficient is defined by

$${h}_{w} = \frac{{q}_{w}}{{T}_{f , w} - {T}_{f , b}} \qquad Eq . 81$$

and the Nusselt number can be presented as

$$Nu = \frac{{h}_{w} ( 4 H )}{{k}_{f}} = \frac{4}{{k}_{1} ( {θ}_{f , w} - {θ}_{f , b} )} \qquad Eq . 82$$

wherein 4H is the hydraulic diameter of the channel.

Nusselt number for interface thermal condition of Model B can be obtained by substituting Equations 30, 32, 55 and 57 in Equations 80 and 82. These results in

$$\begin{matrix} Nu = \frac{{k}_{w} ( 4 H )}{{k}_{f}} = \frac{4}{{k}_{1} [ \begin{matrix}\begin{matrix}{{D}_{0} ( 1 - {η}_{1} )}^{4} + {{D}_{1} ( 1 - {η}_{1} )}^{3} + \\ {{D}_{2} ( 1 - {η}_{1} )}^{2} + {D}_{3} ( 1 - {η}_{1} ) +\end{matrix} \\ {θ}_{f} ( {η}_{1}^{-} ) - {θ}_{f , b}\end{matrix} ]} \\ where & Eq . 83 \\ {θ}_{f , b} = \frac{{θ}_{f , pm} {U}_{p} {η}_{1} + {θ}_{f , om} {U}_{m , open} ( 1 - {η}_{1} )}{{U}_{m}} & Eq . 84 \\ {θ}_{f , pm} = \frac{γ}{( 1 + k ) λ sinh ( λ {η}_{1} )} [ β - k ( 1 - β ) ] [ \frac{sinh ( λ {η}_{1} )}{λ {η}_{1} k} + cosh ( λ {η}_{1} ) ] - \frac{γ {η}_{1}}{3 ( 1 + k )} - \frac{γ}{( 1 + k ) {η}_{1} Bi} & Eq . 85 \\ {θ}_{f , om} = \frac{1}{{U}_{m , open}} [ \begin{matrix}\begin{matrix}\begin{matrix}\begin{matrix}- \frac{{D}_{0}}{14} {( 1 - {η}_{1} )}^{6} + ( \frac{- 0.5 {D}_{1} + {D}_{0} {D}_{9}}{6} ) {( 1 - {η}_{1} )}^{5} + \\ ( \frac{- 0.5 {D}_{2} + {D}_{1} {D}_{9} + {U}_{B} {D}_{0}}{5} ) {( 1 - {η}_{1} )}^{4} +\end{matrix} \\ ( \frac{- 0.5 {D}_{3} + {D}_{2} {D}_{9} + {U}_{B} {D}_{1}}{4} ) {( 1 - {η}_{1} )}^{3} +\end{matrix} \\ ( \frac{- 0.5 {θ}_{f} ( {η}_{1}^{-} ) + {D}_{3} {D}_{89} + {U}_{B} {D}_{2}}{3} ) {( 1 - {η}_{1} )}^{2} +\end{matrix} \\ ( \frac{{θ}_{f} ( {η}_{1}^{-} ) {D}_{9} + {U}_{B} {D}_{3}}{2} ) ( 1 - {η}_{1} ) + {θ}_{f} ( {η}_{1}^{-} ) {U}_{B}\end{matrix} ] & Eq . 86 \\ {D}_{9} = \frac{{α}^{*}}{\sqrt{Da}} ( {U}_{B} - {U}_{p} ) & Eq . 87\end{matrix}$$

The Nusselt number for interface thermal conditions of Models A and C can be obtained by substituting the corresponding equivalence correlations, β=β_{cr} and β=1-D₈Biᵢₙₜη₁ in Equations 83-86, respectively.

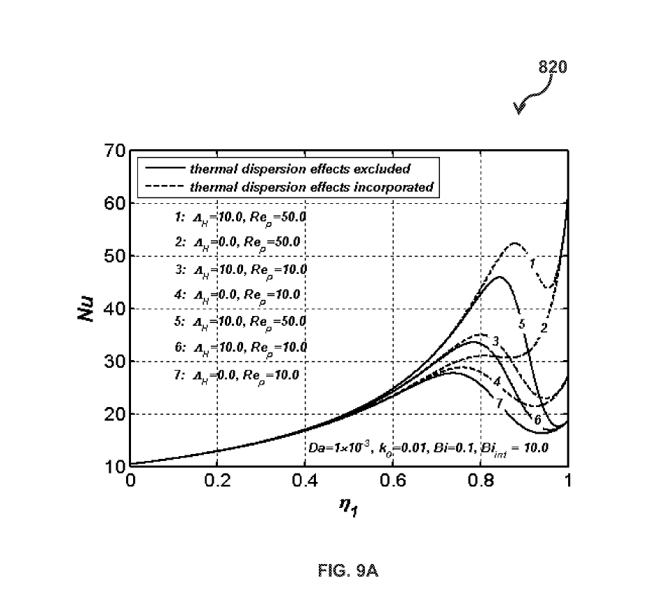

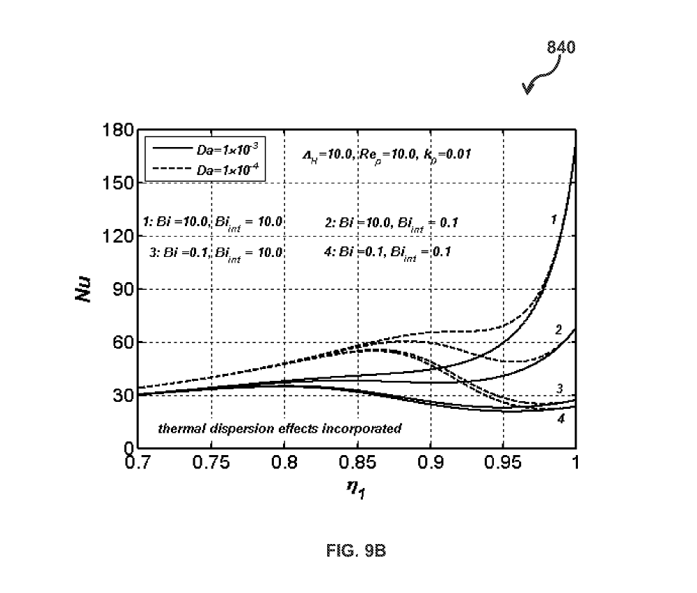

The Nusselt number variations as a function of pertinent parameters Bi, Reₚ, Λ_{H}, and Da are shown as graphs 820 and 840 in FIGS. 9A and 9B. It is found that the Nusselt number increases while the thermal dispersion effect is incorporated. This is because the effective conductivity of fluid phase increases with the inclusion of the thermal dispersion effect. When all the other parameters are unchanged, the Nusselt number will increase while the inertia effect is incorporated. This is because, when Reₚ is unchanged, the total fluid mass flow over the channel cross section will increase with the inclusion of the inertia effect. In most cases, the Nusselt number will increase as Reₚ becomes larger. However, when both the thermal dispersion effect and the inertia effect are excluded, the Nusselt number is independent of Reₚ. When all the other parameters are maintained unchanged, the total fluid mass flow over the channel cross section will increase as Da becomes larger. This results in an enhancement in the Nusselt number, as shown in FIG. 9B. When Bi or Biᵢₙₜ increases, the heat transfer between fluid and solid phases is enhanced inside the porous region or at the interface, thus the Nusselt number will increase, as shown in FIG. 9B. When η₁ is small, the total heat flux transferred into the porous region is also small, thus the influences of Bi, Biᵢₙₜ, Reₚ, Λ_{H}, and Da on the Nusselt numbers become weak, as shown in FIGS. 9A and 9B.

### 2.6 Thermal Dispersion Effect And Inertia Effect

To further investigate the significance of the thermal dispersion effect, the difference between the Nusselt numbers obtained from including and ignoring the thermal dispersion effect is calculated. That is

$${DNu}_{T} = \frac{{Nu}_{T} - {Nu}_{NT}}{{Nu}_{T}} \qquad Eq . 88$$

where Nu_{T} is the Nusselt number adopting the thermal dispersion effect, while Nu_{NT} is the Nusselt number when the thermal dispersion effect is neglected.

To further investigate the significance of the inertia effect, the difference between the Nusselt numbers obtained from adopting the inertia effect or neglecting it is calculated. That is

$${DNu}_{F} = \frac{{Nu}_{F} - {Nu}_{NF}}{{Nu}_{F}} \qquad Eq . 89$$

where Nu_{F} is the Nusselt number which incorporates the inertia effect, while Nu_{NF} is the Nusselt number based on neglecting the inertia effect.

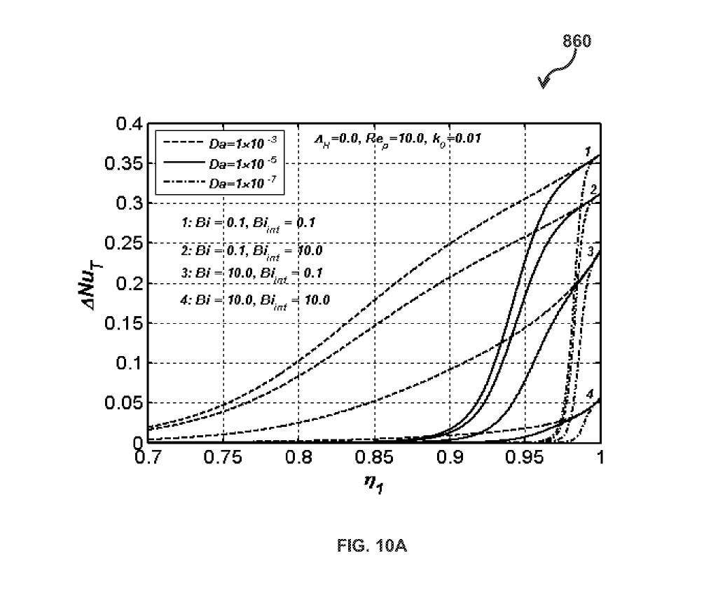

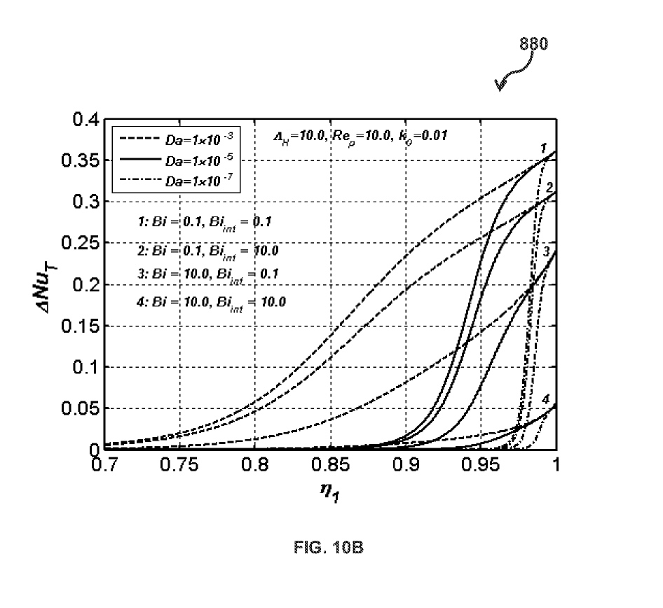

DNu_{T} distributions reflecting the influence of pertinent parameters Bi, Biᵢₙₜ, Reₚ, Λ_{H}, and Da are illustrated in FIGS. 10A and 10B with respect to graphs 860 and 880. As indicated earlier, DNu_{T} decreases as η₁ becomes smaller. It is found that Da plays a major role on the distribution of DNu_{T}. When Da becomes smaller, DNu_{T} will decrease, and approaches zero at larger values of η₁. When η₁ approaches unit, the velocity distribution becomes uniform, thus DNu_{T} for different Da values will approach the same value. When Bi or Biᵢₙₜ increases, DNu_{T} will decrease, which means that the influence of the thermal dispersion effect becomes weaker as the heat exchange between the fluid and solid phases is enhanced. By comparing FIGS. 10A and 10B, it can be seen that the thermal dispersion effect becomes less significant when the inertia effect is incorporated.

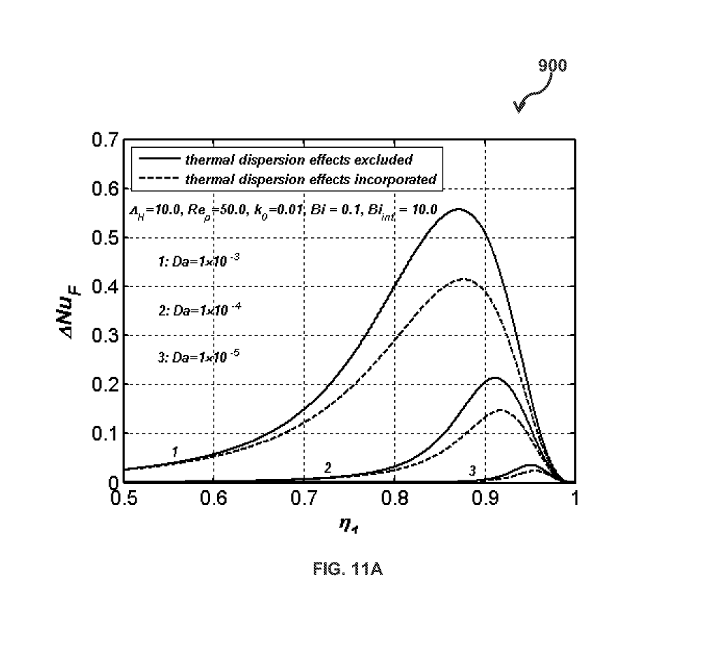

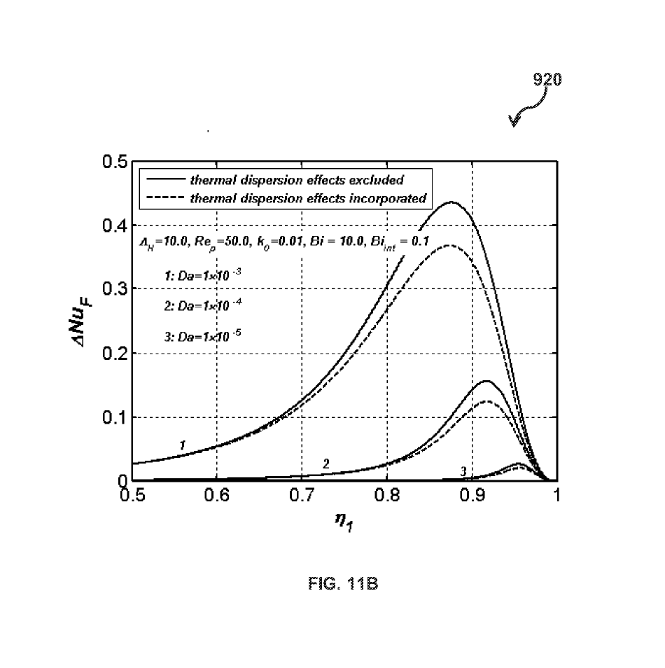

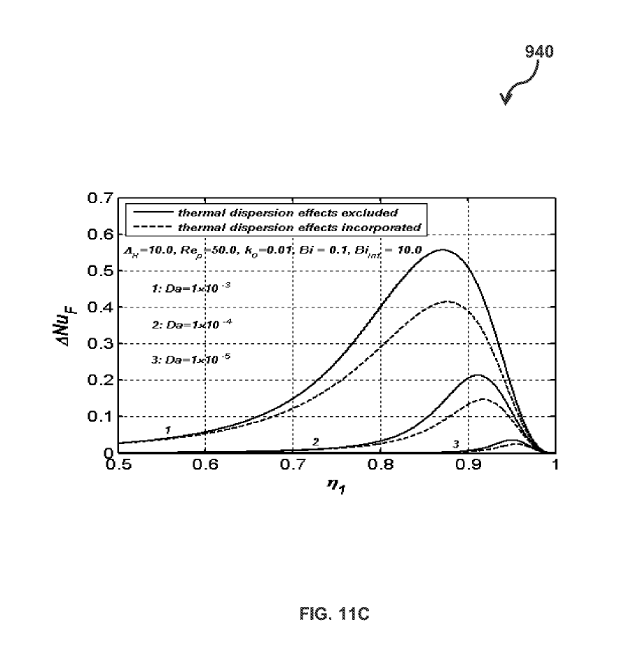

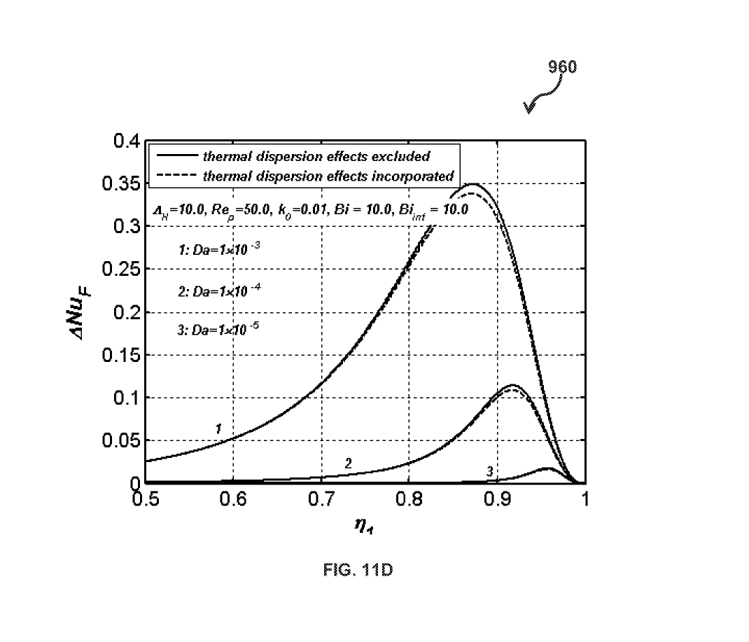

DNu_{F} distributions incorporating the influence of pertinent parameters Bi, Reₚ, Λ_{H}, and Da are respectively depicted in graphs 900, 920, 940, and 960 in FIGS. 11A-11D, in accordance with the disclosed embodiment. From FIGS. 11A-11D, it can be seen that DNu_{F} approaches zero as η₁ becomes smaller or when η₁ approaches unity. As such, the inertial effects are more pronounced for moderate values of It can also be seen that Da plays a major role on the distribution of DNu_{F}. When Da is less than 10⁻⁵, the inertial effect can be neglected. When Bi or Biᵢₙₜ increases, DNu_{F} will decrease, since the influence of the inertial effect becomes weaker as the heat exchange between the fluid and solid phases is enhanced. The inertia effect becomes weaker when the thermal dispersion effect is incorporated.

The phenomenon of heat flux bifurcation within a porous medium is addressed by the disclosed embodiments. Convective heat transfer within a channel partially filled with a porous medium under a LTNE model, with considerations of both thermal dispersion and inertial effects, is discussed herein. Exact solutions can be derived for fluid and solid temperature distributions and a Nusselt number for three interface thermal models at the porous-fluid interface. The range of validity of all interface thermal models can be addressed via the disclosed embodiments.

The equivalence correlations between different interface thermal models are discussed herein. When the heat transfer between the fluid and solid phases does not approach infinity and the temperatures are not equal at the porous-fluid interface, the phenomenon of heat flux bifurcation will occur inside the porous media. The average temperature difference between the fluid and solid phases inside the porous media, in which the phenomenon of heat flux bifurcation should be considered, is used to determine the LTE condition. Results have demonstrated that a critical dimensionless half height of the porous media is a proper parameter, below which the LTE condition within porous region is considered to be valid. Furthermore, the Darcy number and the half height of the porous media are the two major parameters, which can influence the thermal dispersion effect and the inertial effect. The thermal dispersion effect becomes weaker when the inertial effect is incorporated, and the inertial effect becomes weaker when the thermal dispersion effect is incorporated.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for analyzing heat flux bifurcation inside a porous medium, said method comprising:
analyzing convective heat transfer within a channel partially filled with a porous medium under a local thermal non-equilibrium condition;
determining at least one solution for a fluid temperature distribution and a solid temperature distribution;
deriving a Nusselt number solution for three interface thermal models at a porous-fluid interface with respect to said porous medium;
determining local thermal equilibrium conditions with respect to said porous medium by utilizing an average temperature difference between a fluid phase and a solid phase within said porous medium;
analyzing convective heat transfer within the composite system which consists of porous media and adjacent open regions under a local thermal non-equilibrium condition; and
measuring the interstitial heat transfer coefficient between fluid and solid phases in porous media in the presence of the heat flux bifurcation.

2. The method of claim 1 wherein analyzing said convective heat transfer further comprises considering both thermal dispersion effects and inertial effects.

3. The method of claim 1 wherein heat flux bifurcation within said porous medium occurs when heat transfer between said fluid phase and said solid phase does not approach infinity and temperatures are not equal at said porous-fluid interface.

4. The method of claim 3 wherein analyzing said convective heat transfer further comprises considering both thermal dispersion effects and inertial effects.

5. The method of claim 2 wherein heat flux bifurcation within said porous medium occurs when heat transfer between said fluid phase and said solid phase does not approach infinity and temperatures are not equal at said porous-fluid interface.

6. The method of claim 1 wherein analyzing said convective heat transfer further comprises considering both thermal dispersion effects and inertial effects and wherein heat flux bifurcation within said porous medium occurs when heat transfer between said fluid phase and said solid phase does not approach infinity and temperatures are not equal at said porous-fluid interface.
